(19) United States
(12) Patent Application Publication
(10) Pub. No.: US 2005/0148683 A1
(43) Pub. Date: Jul. 7, 2005

(54) Building material having an aggregate processed to remove contaminants therein

(76) Inventors: John Douglas Reid-Gree, Flemington, NJ (US); Gary B. De Santis, Andover, NJ (US); Donald C. Mente, Grosse lle, MI (US); Jimmy I. Patterson, Trenton, MI (US); Robert E. Riley, Brownstown, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/747,325

(22) Filed: Dec. 29, 2003

(51) Int. Cl. C08K 3/34; C08K 3/00

(52) U.S. Cl. 523/129; 524/442; 524/589

(57) ABSTRACT

The subject invention provides a building material useable as a compressed solid or as a foamable product in building projects. The building material is formed from an isocyanate and an aggregate originally having a contaminant present therein. The aggregate has been processed such that the amount of the contaminant is below a predetermined level within the aggregate. The contaminants that may be present in the aggregate include inorganic contaminants, volatile organic contaminants, and synthetic organic contaminants. The aggregate may be obtained from reclaimed soil, reclaimed sediment, reclaimed sludge, reclaimed fill material, and reclaimed mine trailings.

### BACKGROUND OF THE INVENTION

1. Field of the Invention

The subject invention relates to a building material that includes a binder and an aggregate that has been processed to substantially remove a contaminant therein.

2. Description of the Related Art

Various related art building materials are formed from a binder and an aggregate. The binder typically includes isocyanate for bonding with the aggregate. Other building materials also include polyols for producing a foamable building material. The aggregates typically include gravel, sand, rocks, and the like. These are mixed together to form the building material. One such building material is described in U.S. Pat. No. 6,180,192 having an aggregate of soda ash. Still other building materials are described in U.S. Pat. No. 6,235,368 and Great Britain Patent Number 1,557,318. Each of these building materials include sand, rocks, and gravel as the aggregate and form a foamed building material. However, these related art building materials are formed from aggregates that do not contain any contaminants and that have not been processed to remove the contaminants. It is known that there is a limited supply of clean aggregate available, especially since the world's population continues to increase and spread across once undeveloped land. As a result, the formulation of these particular building materials with the clean aggregate continues to erode the already limited supply and it does not improve the environment by eliminating the contaminated aggregates.

Currently, there are numerous locations with useful ground material that has been contaminated. The aggregate becomes contaminated as a result of the specific use of the land. For example, contaminants may seep or leach into the ground near factories that uses chemicals in their operations. These contaminants reach nearby bodies of water and contaminate the sediment at the bottom of the body of water. Typical types of contaminants include, but are not limited to, microbes, radionuclides, inorganic contaminants, volatile organic contaminants, and synthetic organic contaminants. Another possible source of contaminated aggregates include mining operations. During the excavation of the mine, chemicals may be used to extract the desired element from the mine. The chemicals remain in the mine with other residual materials, such as rocks, which together form the contaminated aggregate. The combination of the residual material and the contaminate is typically referred to as mine trailings. These contaminated ground material and mine trailings could be very valuable if put to a worthwhile use.

There are various methods known to those skilled in the art for removing the contaminates from the aggregates. These methods include washing the aggregate with a detergent to remove the contaminant, burning the aggregate, or cooking the aggregate. However, in the past, there have been few applications where use of the previously contaminated aggregates would have been publicly acceptable. To date, there are no building materials that have been made with processed aggregates to remove the contaminants.

Therefore, it would be advantageous to provide a use for such processed contaminated aggregate. It would be further advantageous to provide a method of using the contaminated aggregate that would be publicly acceptable.

### BRIEF SUMMARY OF THE INVENTION AND ADVANTAGES

The subject invention provides a building material useful as a compressed solid. The building material includes a binder and an aggregate. The aggregate has been processed to substantially remove a contaminant therein. The binder is used in an amount of from 1 to 90 parts by weight based on 100 parts by weight of the building material. The aggregate has a diameter of less than 2.5 inches and is used in an amount of from 10 to 99 parts by weight based on 100 parts by weight of the building material. The contaminant present therein is processed to be substantially removed such that the amount present in the aggregate is below a predetermined level. Once the contaminate has been substantially removed, the aggregate is mixed with the binder to form the building material.

The subject invention provides a worthwhile use of previously contaminated aggregates in such a manner that is acceptable to the public. Additionally, the subject invention provides a use for these previously unusable aggregates. The building material may be used as bricks or blocks in landscaping or in the building of various structures. The bricks may be used as an exterior facade on the structure or as a support for the structure. Further, the building material may be used as a foamable building material to be applied to vertical surfaces, similar to that of stucco or plaster. The finished foam building material may then be polished or finished to have a desired appearance.

### DETAILED DESCRIPTION OF THE INVENTION

The subject invention provides a building material useable as a compressed solid or as a foamable product in building projects. The building material may be used in such building projects as constructing new structures, remolding old structures, landscaping, etc. In one embodiment, the building material is used as the compressed solid, i.e., in the form of a block or brick. The compressed solid can be used as a concrete block for use in the structure or as a paver stone in landscaping. In another embodiment, the building material is prepared as a foam that can be sprayed or spread onto the structure, which cures to form a solid. The foam gives an appearance similar to that of stucco or plaster. It is to be appreciated that these uses are only illustrative, and not intended to limit the subject invention.

The building material is formed from at least a binder and an aggregate. The binder is used in an amount of from 1 to 90 parts by weight based on 100 parts by weight of the building material. Preferably, the binder is used in an amount of from 1 to 25 parts by weight based on 100 parts by weight of the building material, and more preferably in an amount of from 5 to 15 parts by weight based on 100 parts by weight of the building material. The binder is preferably an isocyanate having NCO groups as is known to those skilled in the art. The isocyanate may be selected from at least one of toluene diisocyanate (TDI) and diphenylmethane diisocyanate (MDI).

Moreover, the MDI may be selected from at least one of monomeric diphenylmethane diisocyanate (MMDI) and polymeric diphenylmethane diisocyanate (PMDI). When only MDI is used in the subject invention, then the MMDI is used in an amount of from 20 to 80 parts by weight based on 100 parts by weight of the isocyanate and the PMDI is used in an amount of from 20 to 80 parts by weight based on 100 parts by weights of the isocyanate. Preferably, the MMDI is used in an amount of from 30 to 70 parts by weight and the PMDI is used in an amount of from 30 to 70 parts by weight based on 100 parts by weights of the isocyanate. More preferably, the MMDI is used in an amount of from 30 to 60 parts by weight and the PMDI is used in an amount of from 40 to 70 parts by weight based on 100 parts by weights of the isocyanate.

The aggregate used in the subject invention has a contaminant present therein. When the aggregate is used to form the building material, the contaminant is below a predetermined level within the aggregate. This predetermined level is based upon the federal and state Environmental Protection Agencies (EPA) that regulate the amount of contaminants that may be present in the aggregate before it is deemed safe for use. The predetermined level is also regulated by the particular region or area of use of the aggregate, such as by State. Each State has their own variance on the predetermined level, but below a general level is set forth. The aggregate is initially obtained having the contaminant above the predetermined level. The aggregate is then processed to substantially remove the contaminant from the aggregate. The contaminant may still be present in the aggregate after it has been substantially removed based upon the requirements of the EPA and the State. The aggregate would have to be submitted to the regulation departments of the EPA and State to determine if the contaminants are acceptable for use in either a residential area or an industrial area. There are other areas that may have different levels where the aggregate may be used. However, it is to be appreciated that by substantially removed, one skilled in the art would recognize that some contaminants may be completely removed while other contaminants remain below the predetermined level.

The contaminants that may be present in the aggregate include microbes, radionuclides, inorganic contaminants, volatile and/or synthetic organic contaminants. The predetermined amount of contaminant that is acceptable changes based upon the location and upon the particular contaminant. For example, an acceptable amount of inorganic contaminant in a residential area may be below 100,000 mg per 1 kg of aggregate. For an industrial area, the amount of inorganic contaminate may be as high as 200,000 mg per 1 kg of aggregate. One type of inorganic contaminant is mercury and in New Jersey, the amount of mercury that may be present for residential in New Jersey is 14 mg/l kg aggregate, while industrial in New Jersey is 270 mg/l kg aggregate. Whereas in Pennsylvania residential the amount is 66 mg/l kg aggregate and industrial is 840 mg/l kg aggregate. The predetermined amount of organic contaminants is less than 100,000 mg per 1 kg of aggregate for residential use and less than 200,000 mg per 1 kg of aggregate for industrial use. Predetermined amounts of radionuclides and microbes, as would be appreciated by those skilled in the art, may be obtained from the EPA and particular states depending upon the particular use and location.

This list is not an exhaustive list of all potential contaminants, but serves as an illustrative example of potential contaminants known to those skilled in the art. Examples of radionuclides that may be substantially removed include, but are not limited to, alpha emitters, beta emitters, photon emitters, Radium 226, Radium 228, and radon. Examples of inorganic contaminants to be substantially removed include, but are not limited to, antimony, asbestos, barium, beryllium, cadmium, chromium, copper, cyanide, mercury, nitrate, nitrite, selenium, and thallium. Examples of volatile and/or synthetic organic contaminants to be substantially removed include, but are not limited to, benzene, carbon tetrachloride, chlorobenzene, ortho-dichlorobenzene, para-dichlorobenzene, 1,1-dichloroethylene, cis-1,2,dichloroethylene, trans-1,2-dicholorethylene, dichloromethane, 1,2-dichloroethane, 1,2-dichloropropane, ethylbenzene, stryene, tetrachloroethylene, 1,2,4-tricholorbenzene, 1,1,1-trichloroethane, 1,1,2-trichloroethane, trichloroethane, toluene, vinyl chloride, xylene, 2,4-dichlorophenoxyacetic acid, 2,4,5-trichlorophenoxypropionic acid, acrylamide, alachlor, atrazine, benzoapyrene, carbofuran, chlordane, dalapon, di-2-ethylhexyl adipate, di-2-ethylhexyl phthalate, dibromochloropropane, dinoseb, dioxin, diquat, endothall, endrin, epichlorohydrin, ethylene dibromide, glyphosate, heptachlor, heptachlor epoxide, hexachlorobenzene, hexachlorocyclopentadiene, lindane, methoxychlor, oxamyl, polychlorinated biphenyls, pentachlorophenol, picloram, simazine, and toxaphene.

The aggregate may be obtained from reclaimed soil, reclaimed sediment, reclaimed sludge, reclaimed fill material, and reclaimed mine trailings. It is to be understood by those skilled in the art that the terminology reclaimed means taking something unfit for use and making it fit for use. The subject invention is directed toward using aggregate from these locations having the contaminant with the reclaimed aggregate and making it fit for use as the building material. Reclaimed soil may be obtained from locations where the contaminates have leeched into the soil from activities on the surface, such as factories. The reclaimed soil includes top soil, clay, sand, rock, gravel, pebbles, and the like. Reclaimed sediment may be obtained from a bottom of a body of water where the contaminants have seeped into the body of water and have contaminated the sediment. Reclaimed sludge may be obtained near the body of water, but not yet at the bottom, having the contaminants therein. Reclaimed fill material may be obtained from various locations, such as dumps, where the aggregate has been used to fill in the location. Reclaimed mine trailings may be obtained from mines during and after excavation from within the mine. Typically, chemicals are used for or are present during excavation of a desired element from the mine. As the mining continues, residual material accumulates, such as rocks and pebbles. The rocks and pebbles mix with the contaminates and are referred to as reclaimed mine trailings.

The aggregates capable of use with the subject invention have a diameter of less than 2.5 inches. Preferably, the diameter is less than 1.75 inches, and more preferably less than 1 inch. The size of the aggregates impacts the amount of the binder required to sufficiently coat the aggregates. The smaller the aggregate, the more binder that is required, and vice versa. The aggregate is used in an amount of from 10 to 99 parts by weight based on 100 parts by weight of the building material, preferably, from 10 to 75 parts by weight, and more preferably from 10 to 40 parts by weight based on 100 parts by weight of the building material. It is to be appreciated that additional filler is used to form the building material, hence the aggregate may be used in small or large amounts depending upon the particular application.

The aggregate is processed to substantially remove the contaminant prior to forming the building material. The aggregate may be filtered to separate out any pieces larger than a desired size, such as larger than 2.5 inches. Next, the aggregate may be washed with high-pressure water and a detergent for removing the contaminant. The detergent may be formed from, but not limited to, a mixture of surfactants and chleating agents. Examples of suitable surfactants include, but are not limited to, Plurafac® and Iconol®, both commercially available from BASF Corp. One example of a suitable chleating agent is, but not limited to, Trilon®, commercially available from BASF Corp. It is to be appreciated that various mixtures and types of surfactants and chleating agents will be used depending upon the type of aggregate and the type of contaminant to be removed. The washing of the aggregate continues until the amount of the contaminant in the aggregate is below the predetermined levels described above.

Another method of removing the contaminants from the aggregate includes burning the aggregate until the contaminants are below the predetermined level. It is to be appreciated that other methods are known to those skilled in the art for removing the contaminants from the aggregates, such as baking or cooking. Further, multiple operations may be required to substantially remove all of the contaminants that are present in the aggregate such as washing the aggregate may be followed by burning or baking. This may be particularly true if any one of the contaminants is not effected by one of the methods.

The building materials may also include an additive selected from at least one of a cross-linker, a catalyst, a drying agent, a surfactant, a filler material, and water. The cross-linker may be used to ensure that the binder binds with the aggregate to produce the building material having desire physical properties for the intended use. The catalyst increases the curing of the building material. The drying agent absorbs any excess water that might impact the physical properties of the building material during the curing process. The surfactant may be used to increase the flowability of the binder throughout the aggregate and to ensure sufficient coverage to achieve the desired physical properties. Additional filler material may also be used depending upon the final use of the building material. For example, the filler material may include paver slag, pea gravel, quartz stone, silica stone, vermiculite, fibers, etc. The filler material may be selected to produce a final finish on the building material or may be used to increase the strength and bonding of the binder and the aggregate. The additive may also include water to promote the interaction between the binder and the aggregate. If the aggregate initially includes some water, such as with the reclaimed sediment or the reclaimed sludge, then additional water may not be necessary. However, if the aggregate is dry, then the water may be added.

The building material is formed by providing the binder and the aggregate that has been processed to remove the contaminant. The binder and the aggregate are mixed to coat the aggregate with the binder. Hand or machine mixing or agitation are both suitable for the subject invention. If any additives are to be used, they are mixed with the binder and the aggregate. Next, the mixture is cured to form the building material. Depending upon the end use of the building material, it may be poured into a mold to form the compressed solid. The curing of the mixture may include heating the building material or applying pressure to the building material or both. Then the mold is removed and the compressed solid is obtained for use as the building material. Alternatively, the building material may be removed from the mold prior to curing. In this manner, the building material is present in the mold for a short period of time, such as about 20 seconds prior to demolding.

The subject invention may also include a polyol component for producing the foamable building material. The foamable building material is capable of being sprayed or spread onto the structure. The polyol may include polyether polyols and polyester polyols as is known to those skilled in the art. Once the polyol, the binder, and the aggregate are mixed, the material begins to react as is known to those skilled in the art. At this time, the material would be applied to the structure such that it cures while it is on the structure. Therefore, the polyol may not be added until just before applying the mixture to the structure to prevent the building material from curing too quickly. Alternatively, the foamable building material may be prepared and other building materials, such as cement blocks, may be placed in the foamable building material. The foamable building material then cures onto the cement block prior to the cement block being located in the building structure.

The following examples, illustrating the formation of the building material according to the subject invention, as presented herein, are intended to illustrate and not limit the invention.

### EXAMPLES

A building material was formed according to the subject invention. The components that form the composition are listed in parts by weight, unless otherwise indicated. Table 1 below illustrates Examples 1-4 formed according to the subject invention.

TABLE 1
Compositions of Various Building Materials

| Components | Example 1 | Example 2 | Example 3 | Example 4 |
|---|---|---|---|---|
| Reclaimed | 150.00 | 150.00 | 180.00 | 90.00 |
| Aggregate | | | | |
| Binder | 150.00 | 150.00 | 120.00 | 120.00 |
| Drying Agent | 15.00 | 0.00 | 15.00 | 15.00 |
| Catalyst A | 1.00 | 2.50 | 3.50 | 3.50 |
| Catalyst B | 0.00 | 2.00 | 2.50 | 2.50 |
| Anti-Foam Agent | 0.00 | 4.00 | 0.00 | 0.00 |
| Filler Material | 0.00 | 0.00 | 0.00 | 90.00 |

The reclaimed aggregate is reclaimed sediment obtained from the bottom of the New York/New Jersey harbor and has been processed to substantially remove the contaminants therein by washing with high-pressure water and detergents. The binder was LUPRANATE® M20S Isocyanate, commercially available form BASF Corp. The drying agent is a Molecular Seive Type 3A, a potassium form of aluminosilicate. Catalyst A is Potassium Hex Cem 977, commercially available from OMG Americas and catalyst B is POLYCAT® SA-1, commercially available from Air Products and Chemicals, Inc. The anti-foam agent is DABCO® DC-5000, commercially available from Air Products and Chemicals, Inc.

In Example 1, the reclaimed aggregate, the binder, and the molecular were mixed together. Then the catalyst was added and mixed for an additional 15 seconds. The sample was poured into a 2″ round and 4″ deep plastic mold, about ¾ full. The building material cured at room temperature in about 3 minutes and the building material was removed as a cylindrical block.

In Example 2, all of the components were mixed thoroughly together and poured into a metal tray. A face of cinder block was set into the metal tray and placed into an oven for one and a half hours at 110° C. The tray was removed from the oven and the cinder block was removed from the tray. The building material had cured to the face of the cinder block as a coating material.

In Example 3 and 4, all of the components were hand mixed together until thoroughly mixed. The building material was then poured into a rectangular shaped mold having four side walls. A top and a bottom plate were placed on the four side walls and placed in a heated press. The mold was formed of aluminum material. The press was compressed 3000 psi for one hour at 350 degrees F. The compression was to keep the top and bottom plates from moving incase the building material foamed during curing. The mold was removed from the oven and the building material was demolded.

Obviously, many modifications and variations of the present invention are possible in light of the above teachings. The invention may be practiced otherwise than as specifically described within the scope of the appended claims.

1. A compressed solid comprising:
a binder used in an amount of from 1 to 90 parts by weight based on 100 parts by weight of said building material; and
an aggregate processed to substantially remove a contaminant therein and having a diameter less than 2.5 inches, said aggregate used in an amount of from 10 to 99 parts by weight based on 100 parts by weight of said compressed solid.

2. A compressed solid as set forth in claim 1 wherein said aggregate has a diameter less than 1.75 inches.

3. A compressed solid as set forth in claim 1 wherein said aggregate is selected from at least one of reclaimed soil, reclaimed sediment, reclaimed sludge, reclaimed fill material, and reclaimed mine trailings.

4. A compressed solid as set forth in claim 1 wherein said binder is an isocyanate.

5. A compressed solid as set forth in claim 4 wherein said isocyanate is selected from at least one of toluene diisocyanate and diphenylmethane diisocyanate.

6. A compressed solid as set forth in claim 4 wherein said binder is selected from at least one of monomeric diphenylmethane diisocyanate and polymeric diphenylmethane.

7. A compressed solid as set forth in claim 6 wherein said monomeric diphenylmethane diisocyanate is used in an amount of from 20 to 80 parts by weight based on 100 parts by weight of said isocyanate and said polymeric diphenylmethane diisocyanate is used in an amount of from 20 to 80 parts by weight based on 100 parts by weights of said isocyanate.

8. A compressed solid as set forth in claim 6 wherein said monomeric diphenylmethane diisocyanate is used in an amount of from 30 to 70 parts by weight based on 100 parts by weight of said isocyanate and said polymeric diphenylmethane diisocyanate is used in an amount of from 30 to 70 parts by weight based on 100 parts by weights of said isocyanate.

9. A compressed solid as set forth in claim 1 wherein said binder is present in an amount of from 1 to 20 parts by weight based on 100 parts by weight of said building material.

10. A compressed solid as set forth in claim 1 wherein said binder is present in an amount of from 5 to 15 parts by weight based on 100 parts by weight of said building material.

11. A compressed solid as set forth in claim 1 further comprising an additive selected from at least one of a cross-linker, a surfactant, a filler material, a catalyst, an anti-foam, a drying agent, and water.

12. A method of forming a building material, said method comprising the steps of:
providing an aggregate in an amount of from 10 to 99 parts by weight based on 100 parts by weight of the building material, said aggregate having a diameter less than 2.5 inches and having a contaminant present therein;
substantially removing the contaminant from the aggregate;
providing an isocyanate in an amount of from 1 to 90 parts by weight based on 100 parts by weight of the building material; and
mixing the aggregate with the isocyanate to form the building material.

13. A method as set forth in claim 12 further comprising the step of curing the building material.

14. A method as set forth in claim 13 wherein the step of curing the building material is further defined as heating the building material.

15. A method as set forth in claim 14 wherein the step of curing the building material is further defined as applying pressure to the building material to form a compressed solid.

16. A method as set forth in claim 13 wherein the step of curing the building material is further defined as applying pressure to the building material.

17. A method as set forth in claim 12 wherein the step of providing the aggregate is further defined as providing the aggregate having a diameter less than 1.75 inches.

18. A method as set forth in claim 12 wherein the step of providing the aggregate is further defined as providing the aggregate selected from at least one of reclaimed soil, reclaimed sediment, reclaimed sludge, reclaimed fill material, and reclaimed mine trailings.

19. A method as set forth in claim 18 wherein the reclaimed soil, reclaimed sediment, reclaimed sludge, reclaimed fill material, and reclaimed mine trailings have at least one of inorganic contaminants, volatile organic contaminants, and synthetic organic contaminants present therein.

20. A method as set forth in claim 12 wherein the step of substantially removing the contaminants is further defined substantially removing at least one of inorganic contaminants, volatile organic contaminants, and synthetic organic contaminants from the aggregate.

21. A method as set forth in claim 20 wherein the step of substantially removing the inorganic contaminants is further defined as removing at least one of antimony, asbestos, barium, beryllium, cadmium, chromium, copper, cyanide, mercury, nitrate, nitrite, selenium, and thallium.

22. A method as set forth in claim 20 wherein the step of substantially removing the volatile organic contaminants is further defined as removing at least one of benzene, carbon tetrachloride, chlorobenzene, ortho-dichlorobenzene, para-dichlorobenzene, 1,1-dichloro ethylene, cis-1,2,dichloroethylene, trans-1,2-dicholorethylene, dichloromethane, 1,2-dichloroethane, 1,2-dichloropropane, ethylbenzene, stryene, tetrachloroethylene, 1,2,4-tricholorbenzene, 1,1,1-trichloroethane, 1,1,2-trichloroethane, trichloroethane, toluene, vinyl chloride, and xylene.

23. A method as set forth in claim 20 wherein the step of substantially removing the synthetic organic contaminants is further defined as removing at least one of 2,4-dichlorophenoxyacetic acid, 2,4,5-trichlorophenoxypropionic acid, acrylamide, alachlor, atrazine, benzoapyrene, carbofuran, chlordane, dalapon, di-2-ethylhexyl adipate, di-2-ethylhexyl phthalate, dibromochloropropane, dinoseb, dioxin, diquat, endothall, endrin, epichlorohydrin, ethylene dibromide, glyphosate, heptachlor, heptachlor epoxide, hexachlorobenzene, hexachlorocyclopentadiene, lindane, methoxychlor, oxamyl, polychlorinated biphenyls, pentachlorophenol, picloram, simazine, and toxaphene.

24. A method as set forth in claim 12 wherein the step of providing the isocyanate is further defined as providing the isocyanate selected from at least one of toluene diisocyanate and diphenylmethane diisocyanate.

25. A method as set forth in claim 12 wherein the step of providing the isocyanate is further defined as providing the isocyanate select from at least one of monomeric diphenylmethane diisocyanate and polymeric diphenylmethane.

26. A method as set forth in claim 25 wherein the step of providing the isocyanate is further defined as providing the monomeric diphenylmethane diisocyanate in an amount of from 20 to 80 parts by weight based on 100 parts by weight of the isocyanate and providing the polymeric diphenylmethane diisocyanate an amount of from 20 to 80 parts by weight based on 100 parts by weights of the isocyanate.

27. A method as set forth in claim 25 wherein the step of providing the isocyanate is further defined as providing the monomeric diphenylmethane diisocyanate in an amount of from 30 to 70 parts by weight based on 100 parts by weight of the isocyanate and providing the polymeric diphenylmethane diisocyanate in an amount of from 30 to 70 parts by weight based on 100 parts by weights of said isocyanate.

28. A method as set forth in claim 12 wherein the step of providing the isocyanate is further defined as providing the isocyanate in an amount of from 1 to 20 parts by weight based on 100 parts by weight of the building material.

29. A method as set forth in claim 12 wherein the step of providing the isocyanate is further defined as providing the isocyanate in an amount of from 5 to 15 parts by weight based on 100 parts by weight of said building material.

30. A building material comprising:
a binder present in an amount of from 1 to 90 parts by weight based on 100 parts by weight of said building material; and
an aggregate having a contaminant present therein below a predetermined level and a diameter less than 2.5 inches, said aggregate being present in an amount of from 10 to 99 parts by weight based on 100 parts by weight of said building material.

31. A building material as set forth in claim 31 wherein said aggregate has a diameter less than 1 inch.

32. A building material as set forth in claim 31 wherein said aggregate is selected from at least one of reclaimed soil, reclaimed sediment, reclaimed sludge, reclaimed fill material, and reclaimed mine trailings.

33. A building material as set forth in claim 31 wherein said contaminant is selected from at least one of inorganic contaminants, volatile organic contaminants, and synthetic organic contaminants.

34. A building material as set forth in claim 33 wherein said inorganic contaminants includes at least one of antimony, asbestos, barium, beryllium, cadmium, chromium, copper, cyanide, mercury, nitrate, nitrite, selenium, and thallium.

35. A building material as set forth in claim 33 wherein said volatile organic contaminants includes at least one of benzene, carbon tetrachloride, chlorobenzene, ortho-dichlorobenzene, para-dichlorobenzene, 1,1-dichloroethylene, cis-1,2,dichloroethylene, trans-1,2-dicholorethylene, dichloromethane, 1,2-dichloroethane, 1,2-dichloropropane, ethylbenzene, stryene, tetrachloroethylene, 1,2,4-tricholorbenzene, 1,1,1-trichloroethane, 1,1,2-trichloroethane, trichloroethane, toluene, vinyl chloride, and xylene.

36. A building material as set forth in claim 33 wherein said synthetic organic contaminants include at least one of 2,4-dichlorophenoxyacetic acid, 2,4,5-trichlorophenoxypropionic acid, acrylamide, alachlor, atrazine, benzoapyrene, carbofuran, chlordane, dalapon, di-2-ethylhexyl adipate, di-2-ethylhexyl phthalate, dibromochloropropane, dinoseb, dioxin, diquat, endothall, endrin, epichlorohydrin, ethylene dibromide, glyphosate, heptachlor, heptachlor epoxide, hexachlorobenzene, hexachlorocyclopentadiene, lindane, methoxychlor, oxamyl, polychlorinated biphenyls, pentachlorophenol, picloram, simazine, and toxaphene.

37. A building material as set forth in claim 30 wherein said binder is an isocyanate.

38. A building material as set forth in claim 37 wherein said isocyanate is selected from at least one of monomeric diphenylmethane diisocyanate and polymeric diphenylmethane.

39. A building material as set forth in claim 38 wherein said monomeric diphenylmethane diisocyanate is used in an amount of from 20 to 80 parts by weight based on 100 parts by weight of said isocyanate and said polymeric diphenylmethane diisocyanate is used in an amount of from 20 to 80 parts by weight based on 100 parts by weights of said isocyanate.

40. A building material as set forth in claim 38 wherein said monomeric diphenylmethane diisocyanate is used in an amount of from 30 to 70 parts by weight based on 100 parts by weight of said isocyanate and said polymeric diphenylmethane diisocyanate is used in an amount of from 30 to 70 parts by weight based on 100 parts by weights of said isocyanate.

41. A building material as set forth in claim 30 wherein said binder is present in an amount of from 1 to 20 parts by weight based on 100 parts by weight of said building material.

42. A building material as set forth in claim 30 wherein said binder is present in an amount of from 5 to 15 parts by weight based on 100 parts by weight of said building material.

43. A building material as set forth in claim 30 further comprising an additive selected from at least one of a cross-linker, a surfactant, a filler material, and water.
